(19) United States
(12) Patent Application Publication
(10) Pub. No.: US 2010/0235388 A1
(43) Pub. Date: Sep. 16, 2010

(54) SYSTEM FOR COMMUNICATING

(76) Inventor: Michael C. Mayo, Fair Oaks, CA (US)

Correspondence Address: MAIER & MAIER, PLLC, 1000 DUKE STREET, ALEXANDRIA, VA, 22314, US

(21) Appl. No.: 12/403,479

(22) Filed: Mar. 13, 2009

(51) Int. Cl. G06F 17/30; H04W 4/12

(52) U.S. Cl. 707/770; 455/466; 707/E17.001

(57) ABSTRACT

A method and system for communicating. The system and method can include steps for entering data into database and setting conditions for the retrieval of the information. A communications system capable of accessing the data in the database may process this information and use it to contact one or more people associated with the data in the database at predetermined intervals. Following the receipt of feedback from the parties who were contacted, the communications system may cease contact with the one or more people associated with the data in the database or may contact still other people associated with the database.

### BACKGROUND

Modern communications employ a variety of formats. Wireless telephones, personal digital assistants and other mobile or portable communication devices are capable of sending and receiving voice calls, data calls, SMS messages, email, facsimiles and other data rapidly and securely. Communication through any of these devices has enhanced the field of communication, allowing professionals to remain in contact with their places of employment despite being remotely located and allowing individuals to remain in close contact with others despite geographic differences. In some instances, mobile and portable communication devices are used by people to relay information about their location during travel.

Also, modern communication has allowed people to make and secure travel through wired or wireless applications from any location. Travel data or any other data may be stored and/or secured in a database that may be accessed by a user to review or share his or her travel plans. However, this data is often not easily accessible by other parties whom a person traveling may wish to share their travel data or itinerary. Further, in some instances, it may be desirable for another party, such as a business associate or family member, to gain access to the travel data or itinerary of a person to whom they desire to remain in contact or in situations where a person on travel may require assistance in their travels.

### SUMMARY OF THE INVENTION

An embodiment of the invention includes a method of communicating. The method may include a variety of steps, such as entering contact information into a database and entering itinerary information into a database. The method may have a further step of setting conditions for a communication system associated with the database to communicate with a remotely located communication device as well as communicating with the remotely located communication device by the communication system associated with the database when a first condition is met. The method may then include a step for performing a first action when the remotely located communication device provides an appropriate response to the communication between the communication system associated with the database and the remotely located communication device and then can have a step for performing a second action when the remotely located communication device provides an inappropriate response to the communication between the communication system associated with the database and the remotely located communication device. The method also includes a step for performing a third action when the remotely located communication device fails to provide a response to the communication between the communication system associated with the database and the remotely located communication device.

Another exemplary embodiment may include a system for communication. The system can include database that houses data. The system may also have a first communication device that communicates with the database through a second communication device, the first communication device provides data to the database, the database housing the data provided by the first communication device and a second communication device that accesses data in the database and communicates with the first communication device. In some exemplary embodiments, the second communication device retrieves information from the database and attempts to communicate with the first communication device at predetermined intervals.

A third exemplary embodiment may include a method of providing information. This method may include means for storing personal data of a client as well as means for storing contact information of the client. The method may also incorporate means for accessing the stored personal data and contact data of the client in addition to means for processing the stored personal data and contact data of the client. Further, the method can have means for facilitating communication between the client and the means for processing and means for communicating the status of the client to the means for processing. The method may also have means for determining if at least a second party is to be contacted regarding the client.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is an exemplary diagram showing a computer system.

FIG. 2 is an exemplary diagram showing an exemplary communication system.

FIG. 3 is an exemplary flowchart showing a communication methodology.

FIG. 4 is another exemplary flowchart showing a communication methodology.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiment” and “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

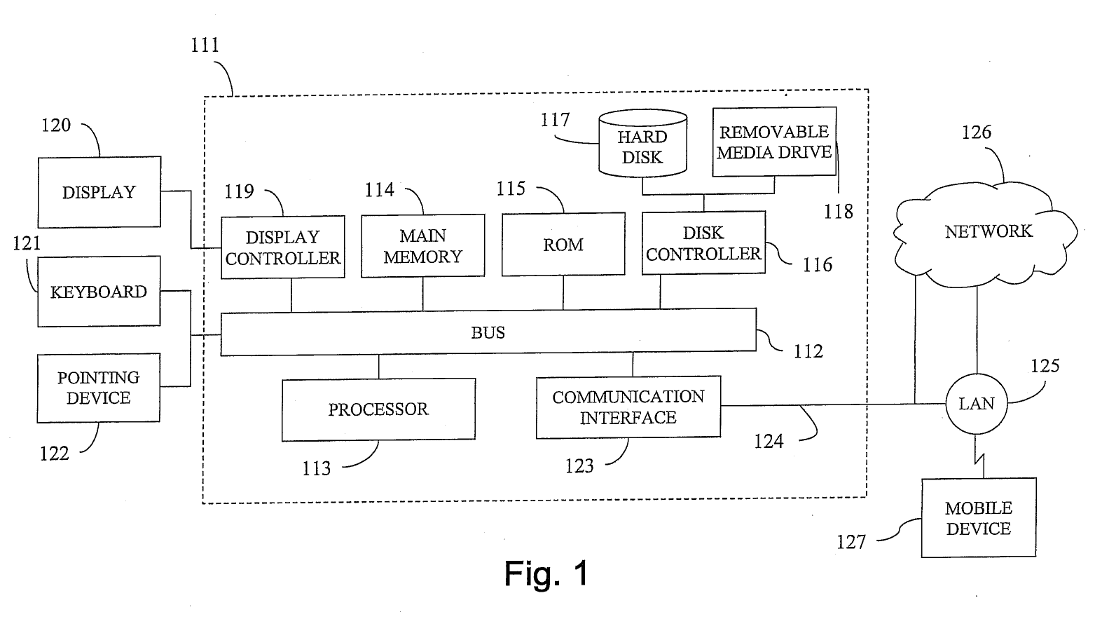

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer client 204. The computer system includes input devices, such as a keyboard 121 and a pointing device 122, for interacting with a computer client 204 and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client 204. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., a LAN) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

In one exemplary embodiment, a method and system for communicating are disclosed. The system may utilize any of a variety of communication devices, for example one or more wireless telephones, one or more traditional telephones, one or more devices capable of connecting to the Internet, one or more servers and one or more databases. Additionally, the system may allow for the communication of data or a message to one or more parties through the one or more wireless telephones, one or more devices capable of connecting to the Internet or one or more traditional telephones.

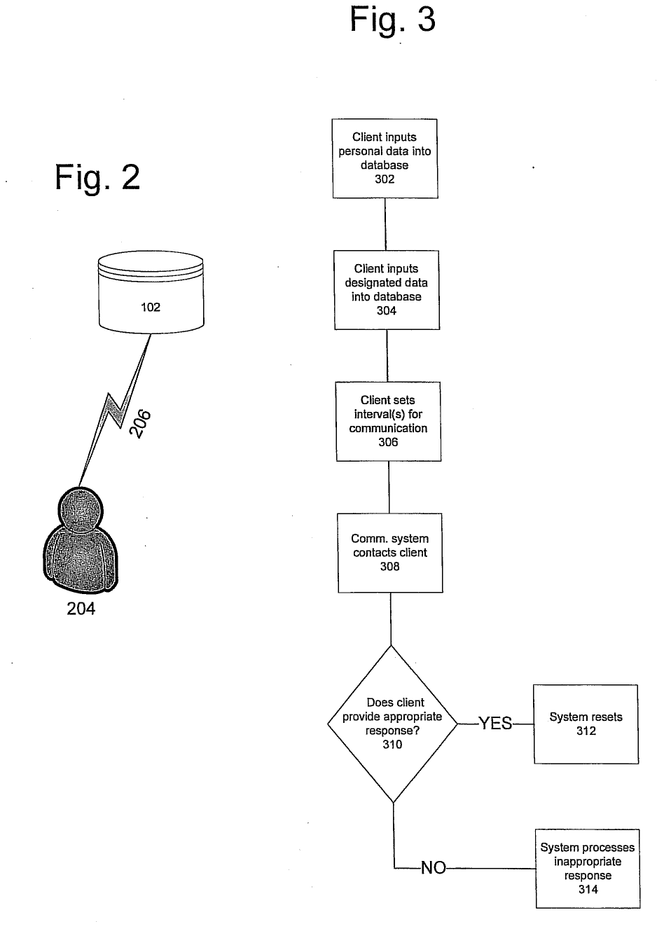

In one exemplary embodiment, as shown in FIG. 2, a database 202, similar to that described with respect to FIG. 1, may be accessed and data may be deposited within the database 202. The database 202 may be any type of known database and may be accessible in any known manner, for example through a communication link 206 between the database 202 and communication device or computer or combination thereof. Additionally, the database 202 may be capable of storing any of a variety of information in any of a variety of formats. For example, the database 202 may be capable of receiving information from a client 204 through the use of a communication service. The client 204 may connect to the database 202, for example using a wireless telephone or personal digital assistant (PDA) (not pictured). The client 204 may then submit any of a variety of contact information to the database 202. The contact information may include the client's name, address, telephone number or numbers, email, travel itinerary and any other desired data. Additionally, the contact information may be the contact information of any person or party who the client 204 may desire to contact or desire to have access to the information the client 204 has provided to the database 202.

In a further exemplary embodiment, the client 204 may leave any other additional data on the database 202. In some exemplary embodiments, the client 204 may be prompted by a program associated with the database 202 to leave any of a variety of information or data. In one example, the client 204 may be prompted to leave a voice message, picture message, text message or any other form of media message. Further, the message may contain information regarding the client 204. This information may be related to the travel, schedule or movement of the client 204. Therefore, the information may be a voice message or a text message stating the client 204's travel itinerary, such as the date and time of a flight, the location of a flight, the location of a hotel where the client 204 may be staying, the rental car company through which the client 204 is renting a car and/or any other information that may be associated with travel.

After inputting any desired information in the database 202, the client 204 may be prompted or may set a time which he or she wishes to be contacted. The client 204 may be prompted to be contacted for any of a variety of reasons, for example to have the program associated with the database 202 check to see whether or not the client 204 successfully completed a portion of their travel or to see if the client 204 successfully arrived at a desired destination. Thus, in a further example, the client 204 may provide an input into the database 202 that prompts a program or service associated with the database 202 to communicate with the client 204. The communication with the client 204 may be any type of communication that the client 204 desired and may be any type of known communication, for example a phone call, a text message, an email or any other type of communication that the client 204 desires and that the client 204 may receive or utilize. Further, the client 204 may prompt the database 202 or a program or system associated with the database 202 to contact the client 204 at any time. In a further example, the client 204 may desire to be contacted at a time when he or she is supposed to have reached their destination, for example after the scheduled landing time of a flight the client 204 is taking. Other examples may include prompting a communication at the time when the client 204 is scheduled to arrive at their destination by any other mode of transportation or at any predetermined intervals during which the client 204 may be traveling and may have access to a device which may receive any such communications. Further, the time at which the database 202 may be scheduled to communicate with the client 204 may be any predetermined date and time, time of time or period of time at which the client 204 may desire to be contacted.

In some examples, the client 204 may desire to be prompted for communication to provide a status update on his or her travels or to provide some assurance or information that they have successfully completed some travel or portion of travel. In still other examples, the client 204 may desire to communicate to others that he or she did not successfully complete some travels or that he or she is in danger.

In yet another exemplary embodiment, the client 204 may receive any desired communication from the database 202 and may provide additional information to the database 202 at that time. For example, if the client 204 has successfully completed a leg of travel or successfully arrived at an end destination, he or she may communicate to the database 202 and/or program that he or she arrived successfully and there is no other information to report (e.g., that his or her health is fine, that he or she is not in any danger, physical or otherwise, or that there are no other known or apparent problems). This communication may be made from the client 204 to the database 202 in any of a variety of manners. For example, if the client 204 prompted the program to call him or her at a predetermined time, the client 204 may simply receive the incoming call from the program to indicate that he or she does not require further contact regarding this communication. In another example, the client 204 may receive a phone call and be prompted to say a predetermined word, a code word or safe word or otherwise provide a known or valid indicator that he is she does not require any additional communications or that he or she is not in any physical danger. The system may then accept the input from the client 204 and that transaction between the client 204 and the system will be complete. In such examples, the system may no longer communicate with the client 204 regarding that scheduled reminder and may wait to communicate with the client 204 until further prompted or until the time for another scheduled communication arrives. In other examples where the communication does not take place via telephone, the client 204 may respond in kind. For example, if the system sends a text message, the client 204 may respond via text message. Further, in other examples, the manner of response by the client 204 and the manner of communication by the system may be separate, for example the system may send the client 204 a text message and the client 204 may respond by calling the system via telephone.

In one example, if the client 204 has experienced a flight delay or traffic while driving, the system may still communicate with him or her at the predetermined time. The client 204 may respond to the system using one or more predetermined or known word or code. This word or code may indicate to the system that the client 204 is experiencing a delay but that he or she is otherwise fine. The system may then have one or more predetermined instructions that prompt to again communicate with the client 204 at a predetermined time or predetermined intervals that allow for the status of the client 204 to be updated or finalized.

In another exemplary embodiment, the system may communicate with the client 204 at a predetermined time, as described previously. However, in this example, the client 204 may wish to indicate that there is a problem, such as an unexpected illness, accident or crime. In this example, after the client 204 receives the communication from the system, they may respond, in any manner, as described previously, with a predetermined word, message or code, such as an “S.O.S.” Alternatively, in some examples, the client 204 may be able to respond in any manner that is other than a prescribed manner, for example as described above, that would indicate that their situation is appropriate or that everything is “O.K.”. This response may be interpreted as one that requires further activity by the system. Thus, depending on any pre-inputted or predetermined instructions by the client 204, the system, upon receiving indication from the client 204 that there is problem, may perform any of a variety of tasks. In some exemplary embodiments, the system may send a communication or information to a predetermined contact or person that the client 204 had inputted into the database 202 earlier or whose contact information the client 204 had previously inputted. Also, if a primary contact as inputted by the client 204 is unavailable or unresponsive, a secondary, tertiary, etc., contact may receive a communication from the system. Similarly, any number of contacts may be made, as desired by the client 204. This communication may provide information to the contact or person that the client 204 has a problem.

In some further exemplary embodiments, the communication may provide information regarding the nature or type of the problem of the client 204. In still other exemplary embodiments, this communication may prompt the contact or person with any desired contact information of the client 204 and may prompt the contact or person to try to communicate with the client 204. Further, in some examples, the communication may include GPS data, showing the location of the client 204 at the time of the indication of a problem. In still other embodiments, the system may contact one or more parties to provide assistance to the client 204, for example the police, paramedics, a doctor or any other relevant or desired party.

In another exemplary embodiment, the system may attempt to contact the client 204, but may not be able to communicate with the client 204 or may not receive a response from the client 204. In this example, the client 204 may be in a situation where they are not able to communicate with the system, for example on a flight or in an area where wireless or wired communication is unavailable. In one exemplary embodiment, the system may record an attempt to communicate with the client 204. A record may be created noting the time and any other known circumstances regarding the communication. In a further embodiment, the system may make a repeat attempt to communicate with the client 204. This repeat attempt may occur at any time, for example a predetermined interval set by the client 204 or at a default time interval. Similar repeat attempts to communicate with the client 204 may be made at any predetermined or preset intervals.

Additionally, in some other exemplary embodiments, if the system is unable to communicate with the client 204 or if the client 204 is unresponsive to a predetermined number of communication attempts, a communication may be made to any previously inputted contact or person, or combination of contacts or people, as described previously. Additionally, a communication may be dispatched to any other desired party, such as the police, paramedics, fire department, etc. Any communication to any party may include information such as where the client 204 was traveling or where he or she is supposed to be, as well as their itinerary, or any other information the system may have about the client 204 or any information that the client 204 has authorized the system to provide in the event that they are unable to communicate. Additionally, if it is available, the system may provide GPS data to any party receiving a communication, so provide an indication of where the client 204 is located or where the communication device of the client 204 may be located.

In still other exemplary embodiments, any time a communication is transmitted to or sent to any party that is not the client 204, a predetermined amount of information may be conveyed to that party. The amount of information transmitted to that party may be preset by the client 204 or may be a default amount of information, as set by the system itself. Additionally, some parties or contacts provided by the client 204 at an earlier time may be communicated more information than other parties or contacts. For example, the system may communicate the date, time and location of the client 204's scheduled travels to one listed contact member but may provide additional information, such as pertinent health information, medical conditions, GPS data or any other such data to another listed contact member.

In another exemplary embodiment, as shown in FIG. 3, an exemplary method of communicating may be shown. Similar to the exemplary embodiments described above, this method may include a client, such as client 204, described previously, providing information to a database, in step 302. The information the client provides may be similar to that described previously, insofar as it may be a listing of personal information, including contact information and any other data, for example vital information. This information may be stored in the database or disseminated as desired by the client.

Still referring to FIG. 3, the client may input some additional data into a database, in step 304. This additional data may be related to a travel schedule, such as a travel itinerary, or may be any other type of data that the client may desire to share with others at a predetermined time or following any of a variety of events. Following the input of this additional data, in step 306, the client may set one or more time periods or intervals during which the client may desire for a communication system associated with the database to contact the client. The communication system may be any known system that may be capable of extracting or reading data that the client has input into a database and may be capable of communicating with the client through any known format or manner, for example wired or wireless telephone, SMS (text message), email, facsimile, and the like. Further, in some exemplary embodiments, the client may set on or more manners in which they desire to be contacted. The client may be contacted by any known means and may be contacted using any of a variety of manners hierarchically, sequentially, simultaneously or in any other manner desired.

Following the input of information in step 306, the communication system may be set or enabled to contact the client, as in step 308. In step 308, the communication system may send a communication to the client in any of the desired formats or manners described previously. Further, the communication may contain any of a variety of information. In some exemplary embodiments, the communication may be in the form of a query or question. The query or question may be brief and may ask for any type of response from the client to indicate that the client successfully received the communication. For example, if the communication system places a telephone call to the client, the communication system may include a message that prompts the client to press the “1” button if the client has successfully completed his or her travel or leg of travel and may ask that the client press any other button if their travel is somehow incomplete or unsuccessful. In other exemplary embodiments, the client may be sent a text message and may be prompted to respond with one or more response options. In further exemplary embodiments, any known manner of sending or responding to a query may be utilized, such as spoken responses, typed or written responses or any other known format of responding.

In step 310, the communication system may evaluate whether or not a response has been received from the client and, if a response has been received, is it the appropriate response. In one exemplary embodiment, if the client has sent an appropriate response to the system's question or query, the system may proceed to step 312, where it may reset. A system reset, as described in step 312, can mean any of a variety of functions. In one example, the system may cease all communication with the client until prompted by the client. In another example, the system may end any communication relating to its present question or query and proceed to any further instructions or prompts that the client may have previously inputted or scheduled. In still other examples, the system may send a communication to any party designated by the client that may inform that party or parties of the client's status (e.g. report a successful or safe journey).

In another exemplary embodiment, the client may not respond to a communication attempt by the system or may respond with an inappropriate response or with another type of response that may be indicative of some type of problem that the client is experiencing. Thus, in step 314, the system may process an inappropriate response (including the lack of a response) by the client.

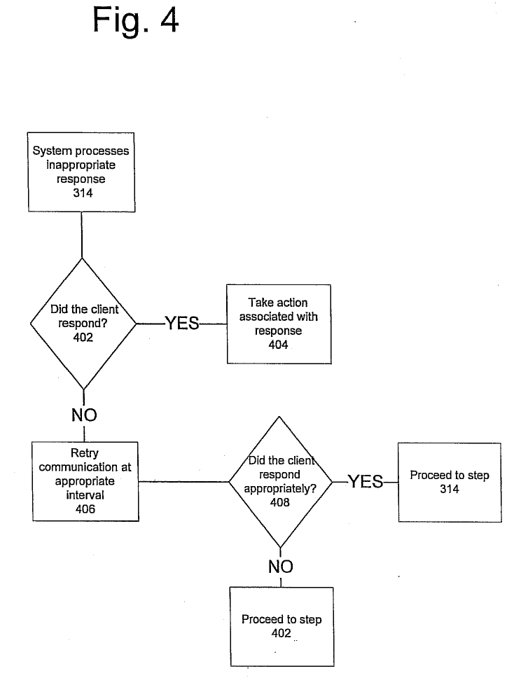

As shown in exemplary FIG. 4, if the system does not receive an appropriate response, a variety of actions may be taken. In one exemplary embodiment, following an inappropriate response in step 314, the system may evaluate, in step 402, if the inappropriate response was an actual response provided by the client or if the inappropriate response was the lack of a response by the client. If the response was an actual response provided by the client, the system may, in step 404, perform an action or response that is associated with the client's response. In one exemplary embodiment, the system can call the client and then prompts the client to press “1” if their situation is normal or if they otherwise do not wish for the system to perform any further action with respect to this prompt or “2” if the client wishes for the system to perform a predetermined action. If the client presses “1”, the actions described previously with respect to step 312 may be taken. Alternatively, if the client presses “2” or, in some further exemplary embodiments, any other non-designated key, non-appropriate message or otherwise non-appropriate response, the system may perform an action that the client has previously designated as appropriate in this situation. In some of these situations, as described previously, this action may be the communication of the client's inputted data to one or more other parties or contacts. In other exemplary embodiments, this action may be to communicate the client's data to law enforcement personnel or emergency medical services.

In further exemplary embodiments, and as shown in step 406, if the client again does not respond to the communication of the system, the system may retry the communication a predetermined number of times at a predetermined interval. In some embodiments the system may retry the communication five more times at ten minute intervals or it may retry the communication any desired number of times at any desired time interval. Similar to the above, in step 408, the system will evaluate if the client responded to the communication appropriately. If the client responds appropriately, the system may proceed to step 314. If the client responds inappropriately, the system may proceed to step 402.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of communicating, comprising:
entering contact information into a database;
entering itinerary information into a database;
setting conditions for a communication system associated with the database to communicate with a remotely located communication device;
communicating with the remotely located communication device by the communication system associated with the database when a first condition is met;
performing a first action when the remotely located communication device provides an appropriate response to the communication between the communication system associated with the database and the remotely located communication device;
performing a second action when the remotely located communication device provides an inappropriate response to the communication between the communication system associated with the database and the remotely located communication device; and
performing a third action when the remotely located communication device fails to provide a response to the communication between the communication system associated with the database and the remotely located communication device.

2. The method of claim 1, wherein the first condition is one of the passage of time or the arrival of a predetermined time and date.

3. The method of claim 1, wherein the communication between the communication system associated with the database and the remotely located communication device further comprises:
requesting confirmation data from the remotely located communication device.

4. The method of claim 1, wherein the first action further comprises:
ending further communication between the communication system associated with the database and the remotely located communication device.

5. The method of claim 1, wherein the first action further comprises:
communicating with the remotely located communication device by the communication system associated with the database when a second condition is met.

6. The method of claim 5, wherein the second condition is one of the passage of time or the arrival of a predetermined time and date.

7. The method of claim 1, wherein the second action further comprises:
communicating information about the remotely located communication device to an outside party.

8. The method of claim 7, where the information communicated to the third party is location information about the remotely located communication device.

9. The method of claim 7, wherein the third party is one of a law enforcement personnel, emergency medical personnel or an emergency contact.

10. The method of claim 1, wherein the third action further comprises:
attempting communication with the remotely located communication device at predetermined intervals until a second condition is met.

11. The method of claim 10, wherein the second condition is one of the providing of a response from the remotely located communication device to the communication system associated with the database or a predetermined number of attempts to communicate between the remotely located communication device and the communication system associated with the database.

12. The method of claim 1, wherein the remotely located communication device is a wireless telephone.

13. The method of claim 1, wherein the communicating between the remote located communication device and the communication system associated with the database is a telephone call.

14. The method of claim 1, wherein the communicating between the remote located communication device and the communication system associated with the database is a SMS message.

15. A system for communication, comprising:
a database that houses data;
a first communication device that communicates with the database through a second communication device, the first communication device provides data to the database, the database housing the data provided by the first communication device
a second communication device that accesses data in the database and communicates with the first communication device;
wherein the second communication device retrieves information from the database and attempts to communicate with the first communication device at predetermined intervals.

16. The communication system of claim 15, wherein the second communication device ceases communication with the first communication device upon receiving an appropriate response from the first communication device.

17. The communication system of claim 15, further comprising:
at least a third communication device,
wherein the second communication device communicates with the at least third communication device upon one of the receipt of an inappropriate response from the first communication device or the failure to receive any response from the first communication device after a predetermined number of communication attempts.

18. The communication system of claim 15, wherein the first communication device and the second communication device communicate through a telephone system.

19. A method of providing information, comprising:
means for storing personal data of a client.
means for storing contact information of the client;
means for accessing the stored personal data and contact data of the client;
means for processing the stored personal data and contact data of the client;
means for facilitating communication between the client and the means for processing;
means for communicating the status of the client to the means for processing; and
means for determining if at least a second party is to be contacted regarding the client.

20. The method of claim 19, further comprising:
means for communicating the location of the client to the at least second party.
